(19) United States
(12) Patent Application Publication
(10) Pub. No.: US 2024/0367188 A1
(43) Pub. Date: Nov. 7, 2024

(54) FLUID PRODUCT DISPENSER

(71) Applicant: APTAR FRANCE SAS, LE NEUBOURG (FR)

(72) Inventor: Gilles JOURDIN, COMBON (FR)

(73) Assignee: APTAR FRANCE SAS, LE NEUBOURG (FR)

(21) Appl. No.: 18/686,294

(22) PCT Filed: Aug. 22, 2022
(86) PCT No.: PCT/FR2022/051594

§ 371 Date: Feb. 23, 2024

(30) Foreign Application Priority Data
Aug. 25, 2021 (FR) FR2108894

(51) Int. Cl. B05B 11/00

(52) U.S. Cl. CPC B05B 11/0008

(57) ABSTRACT

A fluid product dispenser, including: a container provided with a neck forming a helical thread; and a dispensing head mounted on the neck and having a dispensing member and a fastening member that engages both the threaded neck and the dispensing member; where the fastening member has a fastening ring defining a skirt having a sealing element and forming an internal threading, which engages the thread. The fluid product dispenser is characterised in that the sealing element is located axially below the internal threading and comes into radial contact with a lower region of the external peripheral wall that is located below the thread of the container, the sealing element being radially compressed between the skirt and the external peripheral wall.

The present invention relates to a fluid product dispenser comprising a fluid product container provided with an externally threaded neck and internally defining an opening communicating with the inside of the container. The dispenser further comprises a dispensing head that is mounted on the neck of the container, the head comprising a dispensing member, such as a pump or a valve, a pushbutton for actuating the dispensing member and a fastening member that engages both with the threaded neck of the container and with the dispensing member. Such dispensers are frequently used in the fields of perfumery, cosmetics, or also pharmacy.

Generally, the fastening member comprises a fastening ring forming a rigid skirt internally defining one or more threads intended to engage with the threaded neck of the container. To implement the dispensing head on the container, it is sufficient to screw the threaded skirt on the threaded neck of the container. Generally, the fastening member comprises a rigid annular plate which compresses the neck gasket on the annular upper edge of the neck. The final position of the fastening member is determined by the suitable flattening of the neck gasket, which makes it possible to guarantee that the dispenser is leaktight. This final position corresponds to a certain value of screwing torque and to one single axial position of the skirt.

Generally, the neck extends from a shoulder and the fastening member also comprises a trim band which surrounds the skirt of the ring. With these fastening members to be screwed in, it is not possible to create a contact between the lower edge of the trim and the shoulder of the neck. Indeed, it is practically impossible to reconcile both the required screwing torque value and the contact on the shoulder. Either the screwing torque is reached, but there is no contact, or there is contact, but the screwing torque is not reached. In short, both aims cannot be achieved cumulatively in practice.

Without even wishing to come into contact with the shoulder of the container, it would be advantageous for the screwing torque value not to be determined by a compression limit value of the neck gasket. Indeed, the machine that screws the skirts onto the necks is adjusted to achieve a specific rotation value. If this rotation value does not allow the neck gasket to be flattened sufficiently, there is a risk of leakage and/or accidental unscrewing. On the contrary, if this rotation value flattens the neck gasket too much, there is a risk of the neck breaking.

The present invention aims to overcome the abovementioned disadvantages of the prior art by defining a fluid product dispenser, the fastening member of which is sufficiently screwed independently of it being leaktight, and in particular, when it axially abuts against the shoulder of the neck.

To do this, the invention proposes a fluid product dispenser comprising a fluid product container provided with an externally threaded neck and internally defining an opening communicating with the inside of the container, the neck comprising an annular upper edge and an external peripheral wall forming at least one helical thread. The dispenser also comprises a dispensing head that is mounted on the neck of the container, the head comprising a dispensing member, such as a pump or a valve, and a fastening member that engages both with the threaded neck of the container and the dispensing member, the fastening member comprising a fastening ring defining a skirt forming an internal threading which engages with the thread of the neck, the skirt extending downwards from the external periphery of an annular plate, the skirt further being provided with a sealing element. According to the invention, the sealing element is located axially below the internal threading and comes into radial contact with a lower region of the external peripheral wall, which is located below the thread of the container, the sealing element being radially compressed between the skirt and the external peripheral wall.

This denotes the traditional configuration wherein an annular flat gasket is axially compressed between the annular plate of the fastening ring and the upper edge of the neck. Preferably, the sealing element undergoes no or almost no axial compression between the skirt and the external peripheral wall. The sealing element is only compressed radially and undergoes no oblique deformation combining both radial and axial stresses.

According to an embodiment, the sealing element is integral with the skirt, by adherence (overmoulding or bonding, for example) or by mechanical connection.

According to another feature of the invention, the sealing element can be presented in the form of a cylindrical section. The sealing element can have a height which is greater than its wall thickness, for example three times greater. The sealing element can be integral with the skirt by adherence or mechanical holding.

According to a practical embodiment, the skirt can form a crown which extends downwards below the internal threading, the crown forming the lower edge of the skirt, the crown being cylindrical and receives the sealing element on its internal wall. Advantageously, the axial height of the sealing element corresponds substantially to that of the crown.

According to another interesting feature of the invention, the annular plate is out of contact with the upper annular edge, when it is leaktight. Thus, the annular plate, which traditionally serves to compress a flat gasket on the upper edge of the neck, does not limit the axial movement of the fastening ring with respect to the neck.

According to a particularly advantageous aspect, the container comprises a shoulder which extends around the neck and the fastening member can further comprise a trim band, generally metallic, which surrounds the skirt and comes into contact with the shoulder of the container with its lower edge, when the skirt is screwed on the neck. Preferably, the trim band is fixedly mounted around the skirt, both axially and rotatably, its lower edge coming into pressed contact against the shoulder when the skirt is bottom-screwed on the neck, with the sealing element radially compressed between the skirt and the external peripheral wall of the neck.

It is understood that the final screwing torque is no longer determined by the optimal compression of a flat gasket, but by the pressing of the band on the shoulder. The sealing element ensures that it is leaktight, by radial compression over an extended axial range, wherein the final screwing is located. The final leaktight position is obtained after a leaktight sliding between the sealing element and the internal peripheral wall or the skirt.

Thus, it being leaktight is guaranteed after several screwing/unscrewing cycles, while this is not the case with the traditional flat gasket, which requires an always increasing compression.

The scope of the present invention is based on the fact of decoupling the screwing and it being leaktight, so as to reach an optimal fastening by screwing independently of it being leaktight. The leaktight radial contact is perpendicular to the axial movement generated by the screwing. This makes it possible to guarantee a pressing of the band (or of the ring) on the shoulder of the neck, without being concerned about it being leaktight.

The invention will now be more fully described in reference to the accompanying drawings, giving as a non-limiting example, several embodiments of the invention.

In the figures:

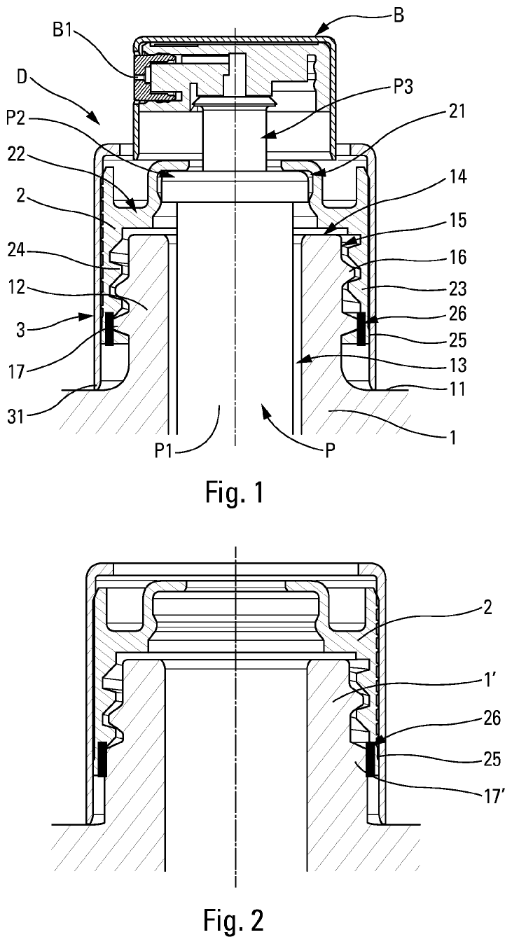

FIG. 1 is a vertical cross-sectional view through a dispenser according to a first embodiment of the invention,

FIG. 2 is a view similar to that of FIG. 1 for a second embodiment of the invention,

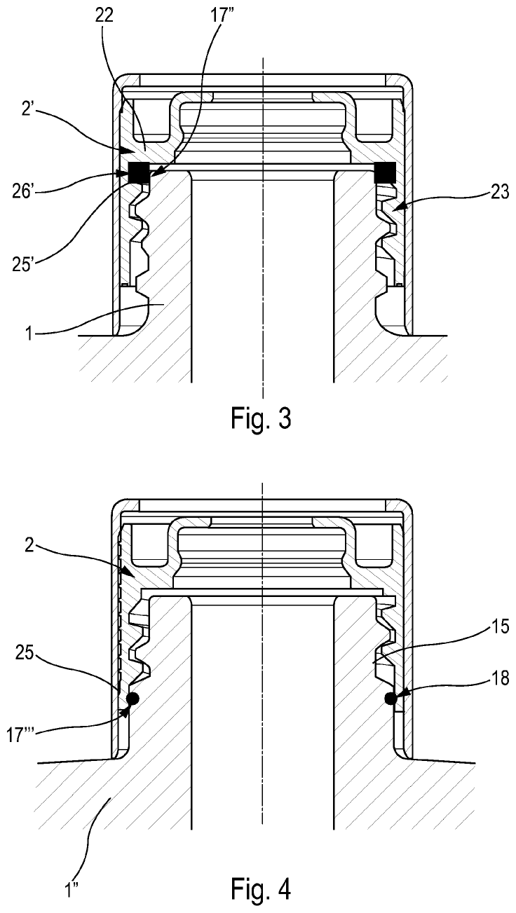

FIG. 3 is a view similar to that of FIGS. 1 and 2 for a third embodiment which does not implement the invention, and

FIG. 4 is a view similar to that of FIGS. 1, 2 and 3 for a fourth embodiment which does not implement the invention.

First, FIG. 1 will be referred to, which illustrates the first embodiment, wherein a dispensing head D is mounted on a fluid product container. The dispensing head D comprises a dispensing member P, which can be a pump or a valve. This dispensing member P comprises a body P1 forming a fastening collar P2, as well as an actuating rod P3 which slides axially back and forth inside the body P1. The dispensing member P is associated with a pushbutton B which forms a dispensing orifice B1.

The fluid product container 1 forms a shoulder 11 from which a neck 12 projects, internally defining an opening 13 which makes the inside of the container communicate with the outside. The neck 12 also defines an upper annular edge 14, as well as an external peripheral wall 15 which forms one (or more) helical screw heads 16.

For the fastening of the dispensing member P on a threaded neck 12 of the container 1, a fastening member 2, 3 is used, which comprises a fastening ring 2. The fastening ring 2 comprises a skirt 23 which is provided internally with an internal threading 24. The skirt 23 is connected at its upper end to an annular plate 22 which is extended to form a receiving housing 21 for the body P1 of the dispensing member P. Advantageously, the dispensing head comprises a trim band 3 which is fixedly engaged around the skirt 23 so as to conceal it. The band 3 is preferably made of metal, but can also be made of plastic material. The band is fixedly mounted around the skirt 23, both axially and rotatably, so as to constitute an entity that is inseparable in normal use.

The neck 12 of the container 1 therefore forms one (or more) threads 16, the step of which corresponds to that of the internal threading 24 of the skirt 23. Thus, the dispensing head can be screwed on the neck 12 by interlocking the internal threading 24 and the external thread 16.

This design is entirely conventional for a fluid product dispenser in the fields of perfumery, cosmetics, or also pharmacy.

While in a conventional dispenser, a flat gasket is disposed on the upper annular edge 14 of the neck 12 so as to be flattened or axially compressed at the end of screwing by the plate 22, in the present invention, a sealing element 26 is disposed between the skirt 23 and the external peripheral wall 15. This sealing element 26, contrary to a traditional flat gasket, is flattened or radially compressed between the skirt 23 and the peripheral wall 15. Preferably, it undergoes no or almost no axial stress. The sealing element 26 is presented, in this case, in the form of a cylindrical section, the height of which is greater, for example three times greater, than its wall thickness. This cylindrical section is integral with the skirt 23 by adherence or mechanical holding. The skirt 23 forms, to this end, a crown 25 which extends downwards below the internal threading 24. The crown 25 forms the lower edge of the skirt 23. The crown 25 is cylindrical and receives the sealing element 26 on its internal wall. The axial height of the sealing element 26 can correspond to that of the crown 25. The thickness of the wall of the sealing element 26 can correspond to that of the crown 25.

As regards the container 1, the external peripheral wall of its neck 12 forms a lower region 17 which comes into leaktight radial contact with the sealing element 26. This lower region 17 is formed by the radial top of an annular contact ridge which projects radially outwards. It can be said that the lower region 17 of the external peripheral wall 15 is located between the thread 16 and the shoulder 11 of the container 1.

Thus, during the screwing of the skirt 23 around the neck 12, the lower region 17 will come into leaktight contact with the internal wall of the sealing element 26 and maintain this leaktight radial contact by a leaktight sliding movement up to the final screwing position. The sealing element 26 offers an axial leaktight range which corresponds to at least one part of the axial screwing stroke. Due to this, it being leaktight is ensured over this axial leaktight range independently of the axial position of the skirt 23 with respect to the neck 12. It can be said that the fastening by screwing is decoupled from it being leaktight, contrary to a conventional flat gasket, the optimal compression of which determines the end of the screwing. With the sealing element of the invention, the end of the screwing is advantageously determined by the pressed axial contact of the lower edge 31 of the trim band 3 against the shoulder 11 of the container 1. It can also be noted that the plate 22 remains away from the upper edge 14 of the neck 12, such that only the contact of the band 3 on the container 1 defines the final screwing position.

It must be noted that the final screwing position is not compulsorily imposed by the pressing of the band 3 on the container 1. The final screwing position can be very well determined with another parameter, since the sealing element 26 guarantees it being radially leaktight over an extended axial range.

With this radial sealing element of the invention, a significant number of screwing/unscrewing cycles can be proceeded with, without affecting the leaktight quality.

This is not the case with an axially compressed conventional flat gasket, which will lose its elasticity after having been highly compressed.

By referring to FIG. 2, a variant of FIG. 1 can be seen, which only differs at the lower region of the neck. While the lower region 17 of FIG. 1 is presented in the form of a projecting annular ridge, the lower region 17′ of FIG. 2 is presented in the form of a thick cylindrical base which extends up to the shoulder 11 of the container 1′. Just like in the embodiment of FIG. 1, the lower region 17′ comes into radial sliding contact with the internal wall of the sealing element 26, which is identical to that of FIG. 1. The sealing element 26 is preferably integral with the crown 25, but it can also be considered to make it integral with the lower region 17′. In this case, it is the crown 25 which would come into sliding contact around the external wall of the sealing element 26.

In the embodiment of FIG. 3, the container 1 can be similar or identical to that of FIG. 1. Its external peripheral wall 15 forms an upper region 17″ between the upper edge 14 of the neck 12 and the external thread 16. This upper region 17″ is cylindrical. The fastening ring 2′ is provided with a sealing element 26′ which is received in a housing 25′ formed at the internal wall of the skirt 23, just below the plate 22. The sealing element 26′ is presented in the form of an O-ring with a square cross-section. It being radially leaktight is ensured by the leaktight sliding of the sealing element 26′ around the upper region 17″. The final leaktight screwing position is determined by the pressing of the band 3 on the shoulder 11 of the container 1. The plate 22 is away from the neck 12.

In the embodiment of FIG. 4, the fastening ring 2 can be similar or identical to that of FIG. 1. It has no sealing element: its crown 25 remains unprotected. As regards the container 1″, its external peripheral wall 15 forms an annular groove or recess 17′″, wherein a sealing element 18 is received, which can be presented in the form of an O-ring, advantageously with a circular cross-section. This annular groove 17″ is located axially below the thread 16, for example at a thick base, like that 17′ of FIG. 2. It being radially leaktight is ensured by the leaktight sliding of the sealing element 18 inside the crown 25. The final leaktight screwing position is determined by the pressing of the band 3 on the shoulder 11 of the container 1. The plate 22 is away from the neck 12.

In all the embodiments, whether the sealing element is integral with the fastening ring or with the neck, a sliding radial contact is established during the screwing before and up to the final screwing position, which can advantageously be defined by the pressing of the band on the container.

1. Fluid product dispenser comprising:
a fluid product container provided with an externally threaded neck and internally defining an opening communicating with the inside of the container, the neck comprising an annular upper edge and an external peripheral wall forming at least one helical thread, and
a dispensing head that is mounted on the neck of the container, the head comprising a dispensing member, such as a pump or a valve, and a fastening member that engages both the threaded neck of the container and the dispensing member, the fastening member comprising a fastening ring defining a skirt forming an internal threading which engages with the thread of the neck, the skirt extending downwards from the external periphery of an annular plate, the skirt being provided with a sealing element,
characterised in that the sealing element is located axially below the internal threading and comes into radial contact with a lower region of the external peripheral wall which is located below of the thread of the container, the sealing element being radially compressed between the skirt and the external peripheral wall.

2. Dispenser according to claim 1, wherein the sealing element is presented in the form of a cylindrical section.

3. Dispenser according to claim 1, wherein the sealing element has a height which is greater than its wall thickness.

4. Dispenser according to claim 1, wherein the sealing element is integral with the skirt by adherence or mechanical holding.

5. Dispenser according to claim 1, wherein the skirt forms a crown which extends downwards below the internal threading, the crown forming the lower edge of the skirt, the crown being cylindrical and receives the sealing element on its internal wall.

6. Dispenser according to claim 5, wherein the axial height of the sealing element corresponds substantially to that of the crown.

7. Dispenser according to claim 5, wherein the wall thickness of the sealing element can correspond to that of the crown.

8. Dispenser according to claim 1, wherein the sealing element undergoes no axial compression between the skirt and the external peripheral wall.

9. Dispenser according to claim 1, wherein the annular plate is out of contact with the upper annular edge, when it is leaktight.

10. Dispenser according to claim 1, wherein the container comprises a shoulder which extends around the neck, the fastening member further comprising a trim band which surrounds the skirt and comes into contact with the shoulder of the container with its lower edge, when the skirt is screwed on the neck.

11. Dispenser according to claim 10, wherein the trim band is fixedly mounted around the skirt, its lower edge coming into pressed contact against the shoulder when the skirt is bottom-screwed on the neck, with the sealing element radially compressed between the skirt and the external peripheral wall of the neck.
